(19) United States
(12) Patent Application Publication
(10) Pub. No.: US 2026/0236006 A1
(43) Pub. Date: Aug. 13, 2026

(54) IMPROVING SERVICE LIFE OF PRINTED OBJECTS

(71) Applicant: INTERNATIONAL BUSINESS MACHINES CORPORATION, Armonk, NY (US)

(72) Inventors: TUSHAR AGRAWAL, WEST FARGO, ND (US); SARBAJIT KUMAR RAKSHIT, KOLKATA (IN)

(21) Appl. No.: 19/051,346

(22) Filed: Feb. 12, 2025

(51) Int. Cl. G05B 19/4099

(52) U.S. Cl. CPC G05B 19/4099; G05B 2219/49023

(57) ABSTRACT

Embodiments receive a design model of a first 3D object from an external application; determine a shape, dimensions, and a service life of the first 3D object by analyzing the design model of the first 3D object; identify types and numbers of second 3D objects based on the shape, the dimensions, and the service life of the first 3D object; create a visual simulation which identifies how the second 3D objects are placed in the first 3D object; print the second 3D objects which are placed in the first 3D object based on the created visual simulation; and dismantle the first 3D object.

### BACKGROUND

Aspects of the present invention relate generally to a system and a method for improving a service life of printed objects.

Three dimensional (3D) printing, also known as additive manufacturing, creates 3D objects by layering materials based on a digital model. In particular, 3D printing builds objects layer by layer by offering greater design freedom and customization possibilities. Further, 3D printing improves on conventional technology by improving versatility, speed, and cost.

### SUMMARY

In a first aspect of the invention, there is a computer-implemented method including: receiving a design model of a first three dimensional (3D) object from an external application; determining a shape, dimensions, and a service life of the first 3D object by analyzing the design model of the first 3D object; identifying types and numbers of second 3D objects based on the shape, the dimensions, and the service life of the first 3D object; creating a visual simulation which identifies how the second 3D objects are place in the first 3D object; printing the second 3D objects which are placed in the first 3D object based on the created visual simulation; and dismantling the first 3D object.

In another aspect of the invention, there is a computer program product including one or more computer readable storage media and program instructions stored on the one or more computer readable storage media to perform operations including: receiving a design model of a first three dimensional (3D) object from an external application; determining a shape, dimensions, and a service life of the first 3D object by analyzing the design model of the first 3D object; identifying types and numbers of second 3D objects based on the shape, the dimensions, and the service life of the first 3D object; creating a visual simulation which identifies how the second 3D objects are place in the first 3D object; printing the second 3D objects which are placed in the first 3D object based on the crated visual simulation; and dismantling the first 3D object.

In another aspect of the invention, there is a system including a processor set, one or more computer readable storage media, and program instructions stored on the one or more computer readable storage media to cause the processor set to perform operations including: receiving a design model of a first three dimensional (3D) object from an external application; determining a shape, dimensions, and a service life of the first 3D object by analyzing the design model of the first 3D object; identifying types and numbers of second 3D objects based on the shape, the dimensions, and the service life of the first 3D object; creating a visual simulation which identifies how the second 3D objects are placed in the first 3D object; printing the second 3D objects are placed in the first 3D object based on the created visual simulation; and dismantling the first 3D object.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows examples of 3D printed objects in accordance with aspects of the present invention.

FIG. 4 shows a flowchart of an exemplary method in accordance with aspects of the present invention.

FIG. 5 shows a flowchart of an exemplary method in accordance with aspects of the present invention.

### DETAILED DESCRIPTION

Aspects of the present invention relate generally to a system and a method for improving a service life of printed objects. In embodiments, the system and method allows for printing second 3D objects that are segmented portions of a first 3D object such that the second 3D objects can replace portions of the first 3D object that are easily prone to being worn down and rendered ineffective. Accordingly, implementations of the present invention save material and recycling costs of the first 3D object by replacing ineffective portions of the first 3D object with the second 3D objects.

Embodiments of the present invention allow for designing of three dimensional (3D) models in such a way that one or more portions of a 3D object can be reused. In particular, aspects of the present invention provide a system, a computer program product, and a computer-implemented method to segment a digital 3D model of a first 3D printed object and print different types of individual second objects that are contained within the first 3D printed object based on the segmented portions of the digital 3D model. In further aspects of the present invention, the system, the computer program product, and the computer-implemented method allow for dismantling of the first 3D printed object after a service life and enable reuse of second 3D printed objects inside the first 3D printed object. Embodiments of the present invention avoid complete recycling of the first 3D printed object.

Embodiments of the present invention identify an expected service life of the first 3D printed object. Aspects of the present invention predict which types of second 3D printed objects may be valuable to keep inside or as a part of the first 3D printed object after the service life of the first 3D printed object. Accordingly, implementations of the present invention modify the digital 3D model of the first 3D printed object to accommodate printing of multiple second 3D printed objects within the first 3D printed object. Aspects of the present invention create the first 3D printed object which incorporates various second 3D printed objects.

Aspects of the present invention print the first 3D printed object with multiple second 3D printing objects inside the first 3D printed object. Embodiments of the present invention conduct comparative strength simulations between the first 3D printed object alone and the first 3D printed object in which multiple second 3D printed objects are inside the first 3D printed object. Further embodiments of the present invention identify a number and types of second 3D printed objects that are placed inside the first 3D printed object based on the comparative strength simulations. Accordingly, implementations of the present invention modify the digital model of the first 3D printed object.

Embodiments of the present invention utilize suitable filler materials to separate and isolate the different second 3D printed objects from each other while printing the first 3D printed object with the multiple second 3D printed objects. Further embodiments of the present invention combine the multiple second 3D printed objects and the filler material to create the first 3D printed object. Aspects of the present invention utilize the second 3D printed objects once the service life of the first 3D printed object is over, and the first 3D printed object is dismantled. In this situation, the filler materials are recycled to enable the reuse of the second 3D printed objects inside the first 3D printed object.

Aspects of the present invention analyze the specifications of different second 3D objects to be printed while modifying the 3D digital model of the first 3D printed object. For example, embodiments of the present invention analyze specifications such as materials of the second 3D objects to be printed, strength of the second 3D objects to be printed, and maximum utilization of space for the second 3D objects to be printed inside the first 3D printed object, etc. Accordingly, implementations of the present invention create (e.g., print) second 3D objects which are placed inside the first 3D printed object.

Embodiments of the present invention dismantle the first 3D printed object by analyzing the digital 3D model after the service life of the first 3D printed object has ended. In this scenario, aspects of the present invention expose the second 3D printed objects inside the first 3D printed object when the first 3D printed object is dismantled. In further embodiments of the present invention, filler material is also recycled. Accordingly, implementations of the present invention provide the necessary strength of the first 3D printed object while reducing the amount of recycling of the first 3D printed object.

Embodiments of the present invention can be applied to a wide range of industries, including construction, healthcare, manufacturing, etc. (e.g., any industry that needs to create objects that are meant to be temporary or used for a specific time). Further embodiments of the present invention improve environmental, social, and corporate governance (ESG) efforts by creating objects that are recycled or repurposed after the objects have served an original purpose. In an example, the materials used to print an object are chosen such that the materials are melted, re-surfaced, or re-manufactured into a new object. Aspects of the present invention improve ESG efforts by choosing materials used to print an object based on biodegradable properties without comprising a required strength in a particular environment (e.g., water, soil, etc.), which depends on an intended use of the object.

Embodiments of the present invention provide a computer-implemented method, a system, and a computer program product for improving ESG efforts of a 3D object. In contrast, conventional systems typically manufacture objects using 3D printing, which is a slow and costly process since the material of the objects are created in a layer by layer process. Further, conventional systems utilizing 3D printing of objects result in significant melting after the service life of the 3D printed object has ended. Accordingly, conventional systems have limitations which prevent re-use of the 3D object and require significant additional costs of re-printing the 3D object after the service life of the 3D object has ended.

Embodiments of the present invention include a system, method, and computer program product for printing second 3D objects that are contained within the first printed 3D object. Accordingly, implementations of the present invention provide an improvement (i.e., technical solution) to a problem arising in the technical field of re-using a 3D printed object. In particular, embodiments of the present invention dynamically create second 3D printed objects which are utilized with portions of the first 3D printed object to re-use the first 3D printed object in response to the service life of the first 3D printed object ending. Further, embodiments of the present invention reduce the amount of recycling required when the service life of the first 3D printed object ends.

Implementations of the present invention are necessarily rooted in computer technology. For example, the steps of creating a visual simulation to identify how second 3D objects are placed in the first 3D object, printing the first 3D object and the second 3D objects, and dismantling the first 3D object cannot be performed in the human mind (or with pen and paper). Creating a visual simulation, printing the first 3D object and the second 3D objects, and dismantling the first 3D object is, by definition, performed by a computer and printing machine and cannot be performed in the human mind (or with a pen and paper). In further embodiments, the steps of performing laser cutting of the first 3D printed object and removing filler materials of the first 3D printed object are also rooted in computer and cutting technology and cannot be performed in the human mind (or with pen and paper).

Aspects of the present invention include a method, system, and computer program product for ameliorating a 3D model of an object. For example, a computer-implemented method includes: identifying a service life of a first object which is to printed by 3D printing; segmenting a digital 3D model of the first object in response to determining that the service life of the first object is limited; utilizing the segmented portion of the digital 3D model to print secondary objects that are contained within the first object; analyzing a modified digital 3D model of the first object and the secondary objects contained within the first object; and dismantling, at the end of the service life, the first object to expose the secondary objects based on the modified digital 3D model. In further embodiments, the computer-implemented method predicts types of secondary objects to be contained within the first object and modifies the digital 3D model to accommodate the 3D printing of the secondary objects within the first object. The computer-implemented method further comprises isolating the 3D printed secondary objects from the first object by a filler material. Embodiments of the computer-implemented method further comprises analyzing specifications of the secondary objects to maximize a space inside the first object.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as 3D printing code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

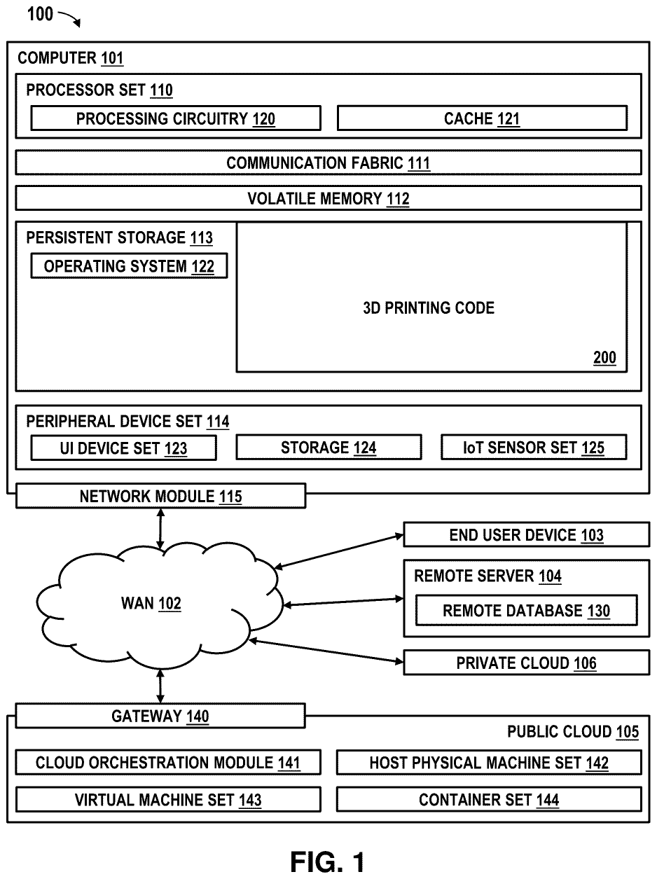

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

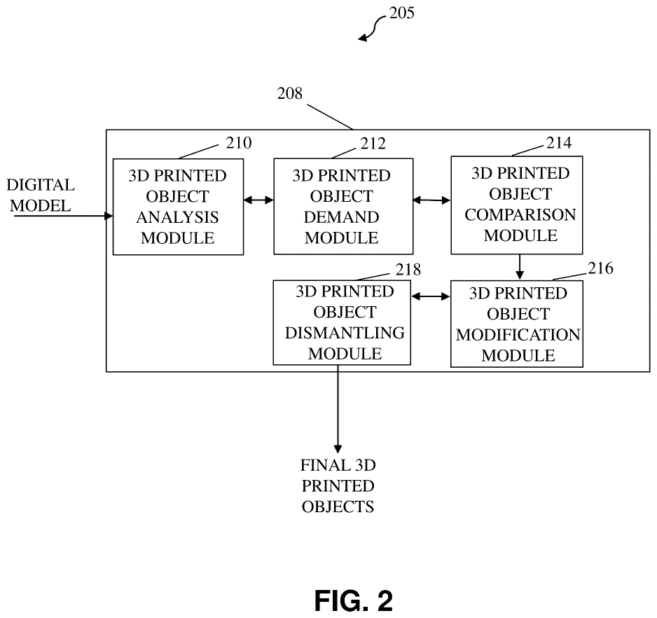

FIG. 2 shows a block diagram of an exemplary environment 205 in accordance with aspects of the present invention. In embodiments, the environment 205 includes a 3D printing server 208, which may comprise one or more instances of the computer 101 of FIG. 1. In other examples, the 3D printing server 208 comprises one or more virtual machines or one or more containers running on one or more instances of the computer 101 of FIG. 1.

In embodiments, the 3D printing server 208 of FIG. 2 comprises a three dimensional (3D) printed object analysis module 210, a 3D printed object demand module 212, a 3D printed object comparison module 214, a 3D printed object modification module 216, and a 3D printed object dismantling module 218, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The 3D printing server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In embodiments, the 3D printed object analysis module 210 receives a digital model from an external application. In further embodiments, the external application comprises a computer aided design (CAD) application. In embodiments of the present invention, the CAD application interprets and visualizes 3D structures, such as the digital model. In aspects of the present invention, the digital model comprises a 3D digital model design which includes digital models of an object and ancillary objects created by CAD software which is used to guide a 3D printing process.

In aspects of the present invention, the 3D printed object analysis module 210 analyzes the digital model to determine a shape of a first 3D object, dimensions of the first 3D object, a load on the first 3D object, environmental parameters of the first 3D object, and strengths for printing the first 3D object. In aspects of the present invention, the load on the first 3D object represents an amount of force and/or weight exerted on the first 3D object. In embodiments, the environmental parameters of the first 3D object comprise data about environmental conditions in which the first 3D object will be used, including temperature, humidity, and other factors that may affect a decomposition process. In embodiments, the 3D printed object analysis module 210 also analyzes the digital model to determine a service life of the first 3D object, identify components of the first 3D object that have a short service life (e.g., support structures), etc. In particular, the 3D printed object analysis module 210 analyzes the digital model to determine the service life of the first 3D object by analyzing material properties of the first 3D object, the structure integrity of the first 3D object, and expected wear and time of the first 3D object. In other words, the 3D printed object analysis module 210 determines lifespans of main components of the first 3D object by analyzing the material properties, the structure integrity, and expected wear and time of the first 3D object. In embodiments, the material properties include information about properties of the materials used to print the first 3D object. In an example, the material properties include at least one of bio-degradable properties within a particular environment, strength and durability of the first 3D object, and other relevant characteristics. The 3D printed object analysis module 210 sends the digital model, the shape, the dimensions, the load, the environmental parameters, the service life, the components that have a short service life, lifespan of the main components, and expected wear and tear of the first 3D object. In aspects of the present invention, the expected wear and tear of the first 3D object is an expected gradual damage or deterioration of the first 3D object that happens as a result of normal use over time.

In embodiments of the present invention, the 3D printed object demand module 212 receives the shape, the dimensions, the load, the environmental parameters, the service life, the components that have a short service life, lifespan of the main components, and expected wear and tear of the first 3D object and identifies specifications of second 3D objects. In particular, the 3D printed object demand module 212 identifies the specifications of the second 3D objects which include a type of objects, materials, strength, shape, and dimensions of the second 3D objects. In further embodiments, the 3D printed object demand module 212 also includes a repository database for storing current and historical specifications of the second 3D objects. Accordingly, the 3D printed object demand module 212 first checks the repository database to identify specifications of the second 3D objects based on historical specifications of the second 3D objects. In embodiments, the historical specifications comprise information about the performance of similar 3D printing objects in the past, including data about lifespan, components that could be re-used upon re-manufacturing, and other relevant details. Then, the 3D printed object demand module 212 identifies the specifications of the second 3D objects based on the received shape, dimensions, load, environmental parameters, service life, components that have a short service life, lifespan of the main components, and expected wear and tear of the first 3D object in response to the 3D printed object demand module 212 not being able to identify the specifications of the second 3D objects from historical specifications of the second 3D objects in the repository database. In further embodiments, the 3D printed object demand module 212 identifies the specifications of the second 3D objects based on the above characteristics of the first 3D object. For example, the 3D printed object demand module 212 identifies the specifications of arms (e.g., second 3D objects) of a robot (e.g., first 3D object) based on the arms of the robot having a short service life in comparison to the remaining parts of the robot. The 3D printed object demand module 212 sends the digital model, the received shape, dimensions, load, environmental parameters, service life, components that have a short service life, lifespan of the main components, and expected wear and tear of the first 3D object and the specifications of the second 3D objects to the 3D printed object comparison module 214.

In aspects of the present invention, the 3D printed object comparison module 214 receives the shape, dimensions, load, environmental parameters, service life, components that have a short service life, lifespan of the main components, and expected wear and tear of the first 3D object and the specifications of the second 3D objects. In further embodiments, the 3D printed object comparison module 214 identifies types and numbers of the second 3D objects which can be placed inside the first 3D object based on the shape and dimensions of the first 3D object. In embodiments of the present invention, the 3D printed object comparison module 214 performs a strength simulation by placing the second 3D objects into the first 3D object to determine whether the first 3D object which contains the second 3D objects retains a same strength as the first 3D object without containing the second 3D objects. In embodiments of the present invention, the 3D printed object comparison module 214 identifies how many maximum number and types of the second 3D objects can be placed inside the first 3D object by determining and utilizing a space available in the first 3D object. In further embodiments of the present invention, the 3D printed object comparison module 214 sends the types and numbers of the second 3D objects which can be placed inside the first 3D object, the digital model, the specifications of the second 3D objects and the shape, dimensions, load, environmental parameters, service life, components that have the short service life, lifespan of the main components, and expected wear and tear of the first 3D object to the 3D printed object modification module 216.

In embodiments of the present invention, the 3D printed object modification module 216 creates a visual simulation on how multiple second 3D objects can be placed in the first 3D object based on the received specifications of the second 3D objects and the shape, dimensions, the load, environmental parameters, service life, components that have the short service life, lifespan of the main components, and expected wear and tear of the first 3D object. For example, the 3D printed object modification module 216 utilizes a computer aided design (CAD) software on a computing device to create the visual simulation on how the multiple second 3D objects can be placed in the first 3D object by utilizing the space available in the first 3D object. In another example, the 3D printed object modification module 216 utilizes a computer aided engineering (CAE) software on the computing device to create the visual simulation on how the multiple second 3D objects can be placed in the first 3D object by utilizing the space available in the first 3D object. In aspects of the present invention, the CAD and/or CAD software displays the visual simulation to a user for feedback and iterative process improvement. In implementations of the present invention, the 3D printed object modification module 216 identifies how the second 3D objects can be placed inside the first 3D object based on the visual simulation. In this situation, the 3D printed object modification module 216 identifies how the second 3D objects can be placed inside the first 3D object based on additional factors (e.g., the load, environmental parameters, service life, components that have the short service life, lifespan of the main components, and expected wear and tear of the first 3D object), rather than being based simply on the shape and dimension of the first 3D object. The 3D printed object modification module 216 also identifies materials for the second 3D objects. In further embodiments, the materials for the second 3D objects are isolated from each other and isolated from filler material. In aspects of the present invention, the 3D printed object modification module 216 performs stress and strength simulations to identify which second 3D objects can be placed inside the first 3D object based on the stress and strength simulations.

In aspects of the present invention, the 3D printed object modification module 216 utilizes a 3D printer to print the second 3D objects inside the first 3D object. In further embodiments of the present invention, the 3D printed object modification module 216 utilizes a plurality of 3D printers and different materials to print the second 3D objects inside the first 3D object. In aspects of the present invention, the 3D printed object modification module 216 utilizes the 3D printer to print the second 3D objects inside the first 3D printed object. In further embodiments of the present invention, the 3D printed object modification module 216 utilizes the plurality of 3D printers and the different materials to print the second 3D objects inside the first 3D printed object. In aspects of the present invention, the 3D printed object modification module 216 utilizes a 3D printer to print the second 3D objects inside the first 3D object simultaneously (i.e., during a same printing process) with the first 3D object. The 3D printed object modification module 216 sends the digital model and the second 3D printed objects inside the first 3D printed object to the 3D printed object dismantling module 218.

In embodiments of the present invention, the 3D printed object dismantling module 218 analyzes the digital model of the first 3D printed object to determine how the second 3D printed objects are placed inside the first 3D printed object. In aspects of the present invention, the 3D printed object dismantling module 218 utilizes a laser cutter to perform laser cutting of the first 3D printed object. In further embodiments of the present invention, the 3D printed object dismantling module 218 utilizes a cutting mechanism to remove filler materials of the first 3D printed object. In aspects of the present invention, the 3D printed object dismantling module 218 exposes and utilizes the second 3D printed objects in response to the filler materials being removed from the first 3D printed object.

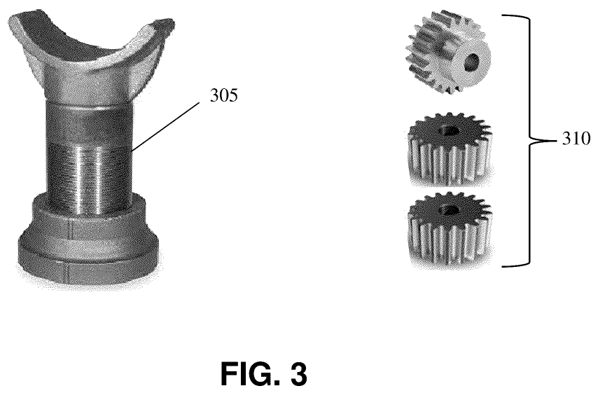

FIG. 3 shows examples of 3D printed objects in accordance with aspects of the present invention. In FIG. 3, the examples of 3D printed objects include a first 3D printed object 305 comprising a pipeline and second 3D printed objects 310 which comprise spare parts of the pipeline. In other embodiments of the present invention, the first 3D printed object 305 comprises a body for a toy and the second 3D printed objects 310 comprises body, arms, and legs for the toy. In other aspects of the present invention, the first 3D printed object 305 comprises a large cube and the second 3D printed objects 310 comprise smaller cubes for the large cube.

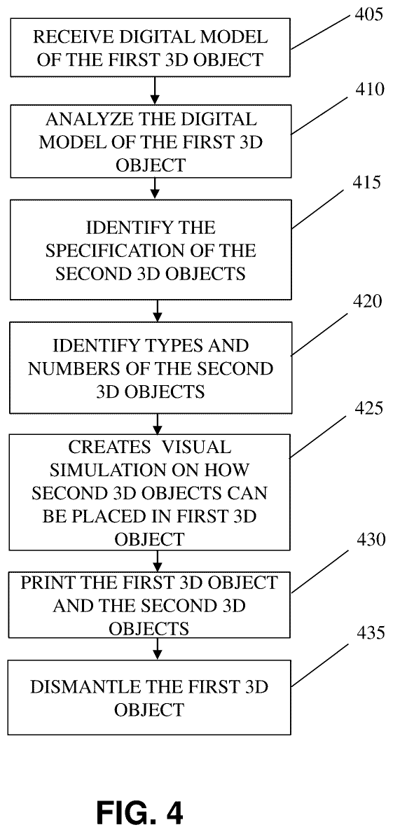

FIG. 4 shows a flowchart of an exemplary method in accordance with aspects of the present invention. Steps of the method may be carried out as operations in the environment 205 of FIG. 2 and are described with reference to elements depicted in FIG. 2.

At step 405, the system receives, at the 3D printed object analysis module 210, a digital model of a 3D object from an external application. In embodiments and as described with FIG. 2, the external application comprises a computer aided design (CAD) application. At step 410, the system analyzes, at the 3D printed object analysis module 210, the digital model to determine a shape of a first 3D object, dimensions of the first 3D object, a load of the first 3D object, environmental parameters of the first 3D object, and strengths for printing the first 3D object. In embodiments and as described with FIG. 2, the 3D printed object analysis module 210 analyzes the digital model to determine a service life of the first 3D object, identify components of the first 3D object that have a short service life, etc.

At step 415, the system identifies, at the 3D printed object demand module 212, the specifications of the second 3D objects. In embodiments and as described with FIG. 2, the specifications of the second 3D objects include a type of objects, materials, strength, shape, and dimensions of the second 3D objects. At step 420, the system identifies, at the 3D printed object comparison module 214, types and numbers of the second 3D objects which can be placed inside the first 3D object. In embodiments and as described with FIG. 2, the 3D printed object comparison module 214 identifies the types and numbers of the second 3D objects which can be placed inside the first 3D object based on the shapes and dimensions of the first 3D object.

At step 425, the system creates, at the 3D printed object modification module 216, a visual simulation on how the second 3D objects can be placed in the first 3D object. In embodiments and as described with FIG. 2, the 3D printed object modification module 216 identifies how the second 3D objects can be placed in the first 3D object based on the visual simulation. At step 430, the system prints, at the 3D printed object modification module 216, the first 3D object and the second 3D objects. In embodiments and as described in FIG. 2, the 3D printed object modification module 216 utilizes a 3D printer to print the first 3D object and the second 3D objects.

At step 430, the system dismantles, at the 3D printed object dismantling module 218, the first 3D printed object. In embodiments and as described in FIG. 2, the 3D printed dismantling modification module 218 utilizes a laser cutter to perform laser cutting of the first 3D printed object. to print the first 3D object and the second 3D objects. In further embodiments and as described in FIG. 2, the 3D printed dismantling modification module 218 utilizes a cutting mechanism to remove filler materials of the first 3D printed object.

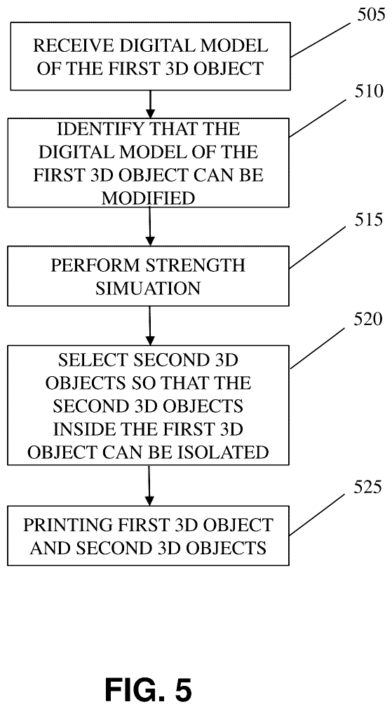

FIG. 5 shows a flowchart of an exemplary method in accordance with aspects of the present invention. Steps of the method may be carried out as operations in the environment 205 of FIG. 2 and are described with reference to elements depicted in FIG. 2.

At step 505, the system receives, at the 3D printed object analysis module 210, a digital model from an external application. In embodiments and as described with FIG. 2, the external application comprises a computer aided design (CAD) application. At step 510, the system identifies, at the 3D printed object demand module 212, that the digital model of the first 3D object can be modified.

At step 515, the system performs, the 3D printed object comparison module 214, a strength simulation by placing the second 3D objects into the first 3D object to determine whether the first 3D object which contains the second 3D objects retains a same strength as the first 3D object without containing the second 3D objects. In step 520, the system selects, at the 3D printed object dismantling module 218, second 3D objects so that the second 3D objects inside the first 3D object can be isolated. In step 525, the system prints, at the 3D printed object modification module 216,, the first 3D object and the second 3D objects. In another example of FIG. 5, the first 3D object is printed at a same time that steps 515-525 are conducted (step 525 culminates in printing of the second 3D objects). In a further example of FIG. 5, the second 3D objects are printed after an end of the service life of the first 3D object. In this scenario, the second 3D objects are printed during dismantling of the first 3D object.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving a design model of a first three dimensional (3D) object from an external application;
determining a shape, dimensions, and a service life of the first 3D object by analyzing the design model of the first 3D object;
identifying types and numbers of second 3D objects based on the shape, the dimensions, and the service life of the first 3D object;
creating a visual simulation which identifies how the second 3D objects are placed in the first 3D object;
printing the second 3D objects which are placed in the first 3D object based on the created visual simulation; and
dismantling the first 3D object.

2. The method of claim 1, wherein the external application comprises a computer aided design (CAD) which interprets and visualizes 3D structures.

3. The method of claim 1, wherein the design model comprises a 3D digital model design.

4. The method of claim 1, wherein the identifying the types and numbers of second objects based on the shape, the dimensions, and the service life of the first 3D object comprises:
identifying specifications of the second 3D objects based on the shape, the dimensions, and the service life of the first 3D object; and
identifying the types and numbers of the second 3D objects based on the identified specifications of the second 3D objects.

5. The method of claim 4, wherein the identifying the specifications of the second 3D objects based on the shape, the dimensions, and the service life of the first 3D object occurs by checking a repository database.

6. The method of claim 1, wherein the printing the second 3D objects which are placed in the first 3D object occurs using a 3D printer.

7. The method of claim 1, wherein the dismantling the first 3D object comprises performing laser cutting of the first 3D printed object using a laser cutting.

8. The method of claim 1, wherein the dismantling the first 3D object comprises removing filler materials of the first 3D printed object using a cutting mechanism.

9. The method of claim 8, wherein the dismantling the first 3D object further comprises exposing the second 3D printed objects in response to the filler materials being removed from the first 3D printed object.

10. The method of claim 1, wherein the first 3D object is dismantled at an end of the service life of the first 3D object.

11. The method of claim 10, wherein the visual simulation which identifies how the second 3D objects are placed in the first 3D object utilizes a space available in the first 3D object.

12. The method of claim 1, further comprising:
predicting the types of second 3D objects to be placed within the first 3D object; and
modifying the design model to accommodate 3D printing of the second 3D objects placed within the first 3D object.

13. The method of claim 1, further comprising:
executing a comparative strength simulation between the first 3D object and the first 3D object containing the second 3D objects; and
identifying the types and the numbers of second 3D objects placed within the first 3D object based on the comparative strength simulation.

14. A computer program product comprising:
one or more computer readable storage media; and
program instructions stored on the one or more computer readable storage media to perform operations comprising:
receiving a design model of a first three dimensional (3D) object from an external application;
determining a shape, dimensions, and a service life of the first 3D object by analyzing the design model of the first 3D object;
identifying types and numbers of second 3D objects based on the shape, the dimensions, and the service life of the first 3D object;
creating a visual simulation which identifies how the second 3D objects are placed in the first 3D object;
printing the second 3D objects which are placed in the first 3D object based on the created visual simulation; and
dismantling the first 3D object.

15. The computer program product of claim 14, wherein the external application comprises a computer aided design (CAD) which interprets and visualizes 3D structures.

16. The computer program product of claim 14, wherein the design model comprises a 3D digital model design.

17. The computer program product of claim 14, wherein the printing the second 3D objects which are placed in the first 3D object occurs using a 3D printer.

18. The computer program product of claim 14, wherein the dismantling the first 3D object comprises performing laser cutting of the first 3D printed object using a laser cutting.

19. The computer program product of claim 14, wherein the dismantling the first 3D object comprises removing filler materials of the first 3D printed object using a cutting mechanism.

20. A system comprising:
a processor set;
one or more computer readable storage media; and
program instructions stored on the one or more computer readable storage media to cause the processor set to perform operations comprising:
receiving a design model of a first three dimensional (3D) object from an external application;
determining a shape, dimensions, and a service life of the first 3D object by analyzing the design model of the first 3D object;
identifying types and numbers of second 3D objects based on the shape, the dimensions, and the service life of the first 3D object;
creating a visual simulation which identifies how the second 3D objects are placed in the first 3D object;
printing the second 3D objects which are placed in the first 3D object based on the created visual simulation; and
dismantling the first 3D object at an end of the service life of the first 3D object.
